(19) United States
(12) Patent Application Publication
(10) Pub. No.: US 2003/0197901 A1
(43) Pub. Date: Oct. 23, 2003

(54) Film scanner

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/419,173

(22) Filed: Apr. 21, 2003

(30) Foreign Application Priority Data
Apr. 22, 2002 (JP) 2002-119469

(51) Int. Cl. H04N 1/04; H04N 1/409; G06T 5/50

(52) U.S. Cl. 358/475; 358/487; 382/275

(57) ABSTRACT

There is provided a film scanner for scanning images formed on a film, which is provided with an illuminating system that emits collimated light to illuminate the film, and an imaging device that receives the collimated light passed through the film to capture the images formed on the film. The film scanner is further provided with a defect position obtaining system that obtains a plurality of images and obtains position data corresponding to a position of an extraneous substance on the film based on a difference between at least two of the plurality of images, the plurality of images being respectively obtained at different conditions of the collimated light incident on the film, and an interpolating system that performs interpolation.

### BACKGROUND OF THE INVENTION

The present invention relates to a film scanner for scanning images formed on a silver-salt film.

Recently, a film scanner for capturing images on a silver-salt film (hereinafter, referred to as a film) has been developed and used. In general, the film scanner is provided with a light source unit for illuminating the film, an imaging lens, and a CCD line sensor. An image on the film is formed on the CCD line sensor by the imaging lens.

By scanning the image on the film in a direction in which the CCD line sensor extends (i.e., in a main scanning direction), while the film is moved relative to the CCD line sensor in a direction perpendicular to the main scanning direction (i.e., in an auxiliary scanning direction), a two-dimensional area on the film is scanned.

Sometimes, there are extraneous substances, for example, foreign particles, or scratches, on the film. Such extraneous substances make defects, such as black spots, in the captured image, thereby an image quality is deteriorated.

A conventional film scanner which includes a plurality of light sources, for example, two light sources, emitting defused light so as to prevent occurrences of defects in the captured image due to extraneous substances is known. This conventional film scanner captures two images respectively formed using the two light sources each of which emits defused light. In this film scanner, the two captured images are compared to detect differences between the two images in order to identify defects formed in the image. If the defects are detected in the image, the defects are corrected using the two image complementarily.

However, this film scanner requires the plurality of light sources, which increases cost of the film scanner or a room for such a light source unit. Further, since the diffused light is used, a difference between the two captured images does not clearly appear. Therefore, the defects on the image can not be corrected sufficiently.

A technique for correcting defects formed on the captured image using an image processing software, such as a photo retouching software running on a personal computer is known. However, in order to correct the image using the photo retouching software, the image has to be input to the personal computer. In addition, an operation of the photo retouching software for correcting defects on the image is generally complicated. In general, some experience is required to correctly use the photo retouching software.

### SUMMARY OF THE INVENTION

It is therefore an object of the invention to provide an improved film scanner which is capable of properly correcting defects on an captured image caused by extraneous substances on a film to be scanned.

According to an aspect of the invention, there is provided a film scanner for scanning images formed on a film, which is provided with an illuminating system that emits collimated light to illuminate the film, and an imaging device that receives the collimated light passed through the film to capture the images formed on the film. The film scanner is further provided with a defect position obtaining system that obtains a plurality of images each of which corresponds to a frame of the film to be scanned using the imaging device, and obtains position data corresponding to a position of an extraneous substance on the film based on a difference between at least two of the plurality of images, the plurality of images being respectively obtained at different conditions of the collimated light incident on the film. The film scanner is further provided with an interpolating system that performs interpolation based on the position data obtained by the defect position obtaining system.

With this configuration, since the collimated light is used to illuminate the film, a black portion on the scanned image caused by the extraneous subject on the film has sharp edges and relatively high density. Accordingly, the black portion on the scanned image caused by the extraneous subject on the film can be reliably distinguished from other pixels in the captured image.

By using different conditions of the collimated light incident on the film, the position data can be obtained.

In a particular case, the illuminating system may be capable of changing an incident angle of the collimated light with respect to the film. In this case, the defect position obtaining system obtains the plurality of images at different incident angles of the collimated light with respect to the film.

In a particular case, the illuminating system may include a single light source which emits light, and a collimating lens that collimates light emitted by the single light source.

Optionally, the illuminating system may include a mirror that reflects the collimated light toward the film, and an angle changing system that changes an angle of the mirror with respect to a predetermined plane to change the incident angle of the collimated light with respect to the film.

Further optionally, the angle changing system may include a motor that rotates the mirror about a rotational axis so as to change the angle of the mirror with respect to the predetermined plane.

In a particular case, the defect position obtaining system may obtain an image when the incident angle of the collimated light with respect to the film is zero and at least one image when the incident angle of the collimated light with respect to the film is not zero.

In a particular case, the defect position obtaining system may obtain the position data based on positions of black portions respectively formed on the plurality of images by the extraneous substance on the film.

In a particular case, the defect position obtaining system may obtain the position data based on a difference between positions of black portions of at least two of the plurality of images, the black portions being respectively formed on the plurality of images by the extraneous substance on the film.

Optionally, the defect position obtaining system may obtain the position data by comparing the distance between the positions of the black portions of the at least two of the plurality of images with a theoretical distance between the positions of the black portions. In this case, the theoretical distance is calculated based on a geometrical condition including incident angles of the collimated light at which the at least two of the plurality of images are obtained.

Still optionally, the interpolating system may perform the interpolation using one of methods of Nearest Neighbor, Bi-Linear and Bi-Cubic.

Optionally, the imaging device may include a line image sensor unit for scanning the film in a main scanning direction, and a auxiliary scanning system that moves the film relative to the line image sensor in an auxiliary scanning direction which is perpendicular to the main scanning direction.

Still optionally, the film scanner may include a storing system that stores an image interpolated by the interpolating system into a memory.

Still optionally, the memory may be an IC-card.

In a particular case, the film scanner may include an interface that is used to communicate with an external device so as to output an image interpolated by the interpolating system to the external device.

According to another aspect of the invention there is provided a film scanner for scanning images formed on a film, which is provided with an illuminating system that emits collimated light to illuminate the film, an imaging device that receives the collimated light passed through the film to capture the images formed on the film. The film scanner is further provided with a defect position obtaining system that obtains position data corresponding to a position of an extraneous substance on the film based on a position of a black portion on an image captured by the imaging device, and an interpolating system that performs interpolation based on the position data obtained by the defect position obtaining system.

With this configuration, since the collimated light is used to illuminate the film, a black portion on the scanned image caused by the extraneous subject on the film has sharp edges and relatively high density. Accordingly, the black portion on the scanned image caused by the extraneous subject on the film can be reliably distinguished from other pixels in the captured image.

According to another aspect of the invention, there is provided a film scanner for scanning images formed on a film, which is provided with an illuminating system that emits collimated light to illuminate the film, an imaging device that receives the collimated light passed through the film to capture the images formed on the film, and a defect position obtaining system that obtains a plurality of images each of which corresponds to a frame of the film to be scanned using the imaging device, and obtains position data corresponding to a position of an extraneous substance on the film based on a difference between at least two of the plurality of images, the plurality of images being respectively obtained at different conditions of the collimated light incident on the film.

According to another aspect of the invention, there is provided a film scanning system for scanning images formed on a film, which is provided with a film scanner that includes an illuminating system which emits collimated light to illuminate the film and which is capable of changing conditions of the collimated light incident on the film, and an imaging device that receives the collimated light passed through the film to capture the images formed on the film. The film scanning system is further provided with an external device that includes an interface for communicating with the film scanner so as to control the film scanner.

In this structure, the external device includes a defect position obtaining system that obtains a plurality of images each of which corresponds to a frame of the film to be scanned using the imaging device, and obtains position data corresponding to a position of an extraneous substance on the film based on a difference between at least two of the plurality of images, the plurality of images being respectively obtained at different conditions of the collimated light incident on the film. Further, the external device includes an interpolating system that performs interpolation based on the position data obtained by the defect position obtaining system.

According to another aspect of the invention there is provided a method for correcting defects on a scanned image caused by an extraneous subject on a film, the method includes performing a first scanning to obtain an image of a frame of the film to be scanned at a first incident angle of light incident on the film, performing a second scanning to obtain an image of the frame of the film to be scanned at a second incident angle of light incident on the film, and determining a position of the extraneous subject on the film using the image obtained at the first incident angle of light and the image obtained at the second incident angle of light.

According to another aspect of the invention there is provided a method for correcting defects on a scanned image caused by an extraneous subject on a film, the method includes performing a first scanning to obtain an image of a frame of the film to be scanned at a first incident angle of light incident on the film, performing a second scanning to obtain at least one image of the frame, the at least one image being obtained at a different incident angle of light incident on the film from the first incident angle, and determining a position of the extraneous subject on the film using the image obtained at the first incident angle of light and the image obtained at the different incident angle of light from the first incident angle.

### BRIEF DESCRIPTION OF THE ACCOMPANYING DRAWINGS

FIG. 1 is a perspective view of a part of a film scanner according to an embodiment of the invention;

FIG. 2 is a side view of the part of the film scanner viewed along an arrow Y shown in FIG. 1;

FIG. 3 is a perspective view of a film holder in a situation where a hinge cover is opened;

FIG. 4 is a perspective view of an appearance of an APS film adapter;

FIG. 5 is a circuit diagram of the film scanner according to the embodiment of the invention;

FIG. 6 is a flowchart illustrating a scanning operation of the film scanner;

FIG. 7 is a flowchart illustrating a command processing called at step S200 in FIG. 6;

FIG. 8 is a flowchart illustrating a correction pre-scan process called at step S300 in FIG. 7;

FIG. 9A schematically shows a relationship of incident angles θ₁, θ₂ and θ₃ of collimated light with respect to a film F;

FIGS. 9B-9D are examples of images including shadows cast by a foreign particle M on the Film F obtained using collimated light at incident angles θ₁, θ₂ and θ₃, respectively; and

FIGS. 9E-9G are examples of images including shadows cast by a scratch on the Film F obtained using collimated light at incident angles θ₁, θ₂ and θ₃, respectively.

### DETAILED DESCRIPTION OF THE EMBODIMENTS

Hereinafter, an embodiment according to the invention is described with reference to the accompanying drawings.

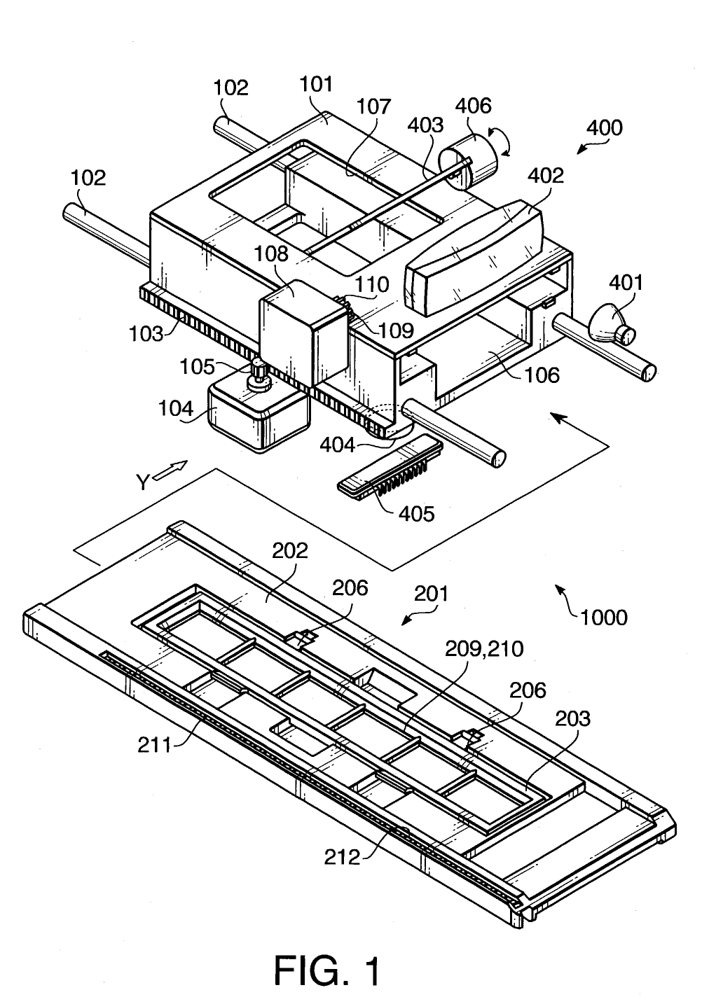

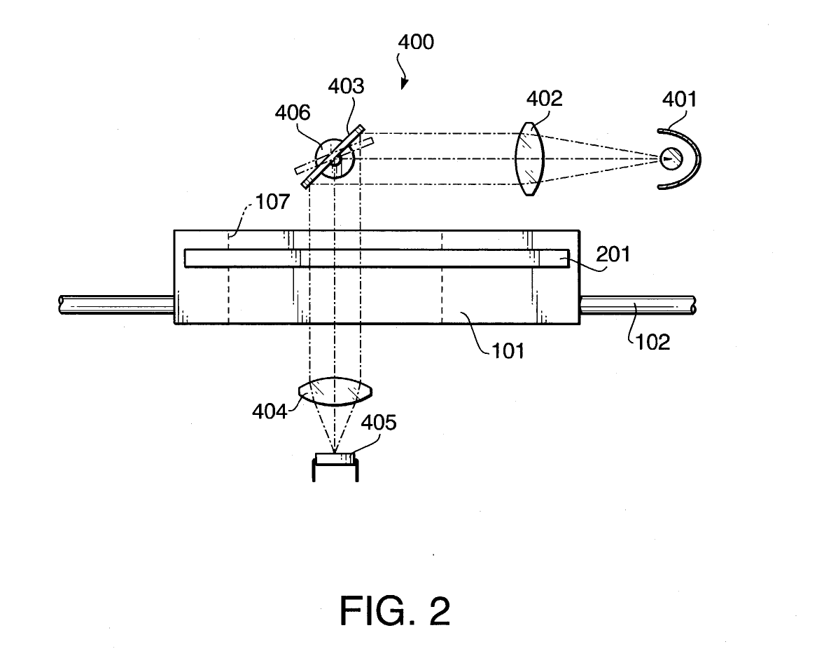

FIG. 1 is a perspective view of a part of a film scanner 1000 according to an embodiment of the invention. FIG. 2 is a side view of the part of the film scanner 1000 viewed along an arrow Y shown in FIG. 1.

As shown in FIG. 1, the film scanner 1000 includes two guide bars 102 and 102 which are fixed to a casing (not shown) of the film scanner 1000, and a table 101 which is mounted on the guide bars 102 and 102 and is slidable along the guide bars 102 and 102.

On a side surface of the table 101, a rack 103 is formed. A main motor 104 is fixed to the casing of the film scanner 1000 such that a pinion 105 fixed to a rotational shaft thereof is engaged with the rack 103 of the table 101. As the main motor 104 is driven, the table 101 moves along the guide bars 102 and 102.

In this embodiment, a direction in which a CCD line sensor unit 405 extends is defined as a main scanning direction, while a direction, which is perpendicular to the main scanning direction, in which the table 101 moves is defined as an auxiliary scanning direction.

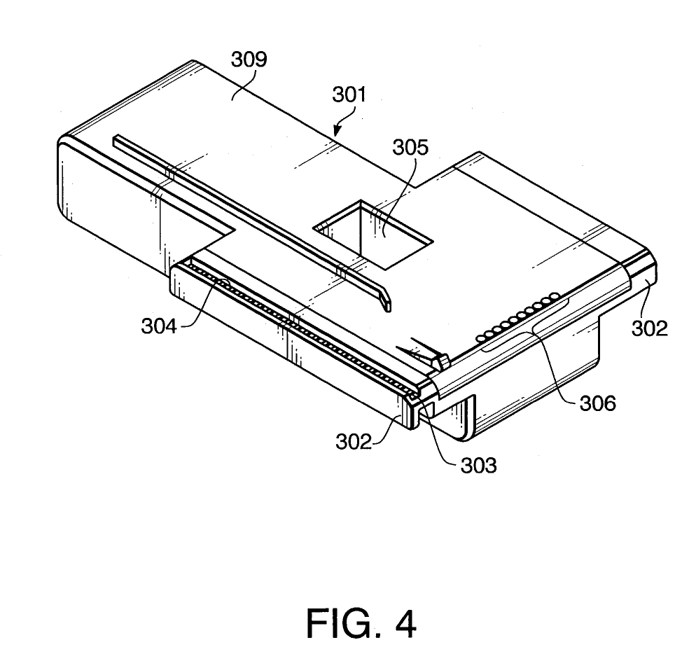

As shown in FIG. 1, inside the table 101, a holder supporting groove 106 is formed in parallel with a direction in which the table 101 moves. As described below, a film holder 201 which is configured to hold a 35 mm film or an APS film adapter 301 which is configured to hold an APS (the Advanced Photo System) film can be inserted in the holder supporting groove 106 (see FIG. 1 and FIG. 4).

Further, the table 101 has a reading window 107 which penetrates from a top surface to a bottom surface of the table 101. A frame of the film to be scanned is exposed via the reading window 107.

Further, on the side surface of the table 101, a pre-scan motor 108 is fixed such that a pinion 109 fixed on a rotational shaft of the pre-scan motor 108 is engaged with a rack 212 formed on the film holder 201 when the film holder 201 is inserted in the holder supporting groove 106 or engaged with a rack 304 formed on the APS film adapter 301 when the APS film adapter 301 is inserted in the holder supporting groove 106.

The main motor 104 and the pre-scan motor 108 are stepping motors.

Above the upper surface of the table 101, a reading optical system 400 is arranged. The reading optical system 400 includes a light source 401 which is positioned such that an optical axis thereof is parallel with the guide bars 102 and 102. That is, the optical axis of the light source 401 is parallel with a horizontal plane. The reading optical system 400 further includes a collimating lens 402, a deflecting mirror 403, an imaging lens 404 located beneath the deflecting mirror 403 and under the table 101, and a CCD line sensor unit 405 (see FIG. 2). The CCD line sensor unit 405 converts an image formed thereon by the imaging lens 404 to an electronic signal.

The light source 401 has characteristics equal to or substantially equal to characteristics of a point source of light emitting white light. The collimating lens 402 collimates light emitted by the light source 401 such that the collimated light has a width larger than a width of the reading window 107 in a direction perpendicular to the direction in which the table 101 moves.

The deflecting mirror 403 is fixed to a rotational shaft of a motor 406 attached to the casing of the film scanner 1000, and therefore, the deflecting mirror 403 is rotatable about an axis perpendicular to the auxiliary scanning direction. That is, an angle of inclination of the deflecting mirror 403 with respect to the horizontal plane can be controlled.

In a typical case, the angle of inclination of the deflecting mirror 403 with respect to the horizontal plane is set at 450. A solid line of the deflecting mirror 403 indicated in FIG. 2 corresponds to this case. In this case, the deflecting mirror 403 reflects the collimated light toward the CCD line sensor unit 405 such that the reflected light proceeding to the CCD line sensor unit 405 is perpendicular to a light receiving surface of the CCD line sensor unit 405.

The CCD line sensor unit 405 includes three line sensors for RGB (Red, Green and Blue) components. Each of the line sensors includes a predetermined number of CCD elements arranged in line in the main scanning direction. By reading the image formed on the CCD line sensor unit 405 sequentially along a direction of elongation of the line sensor, a main scanning operation of the image is performed. Thus, a color image is obtained. In this embodiment, the motor 406 is a stepping motor.

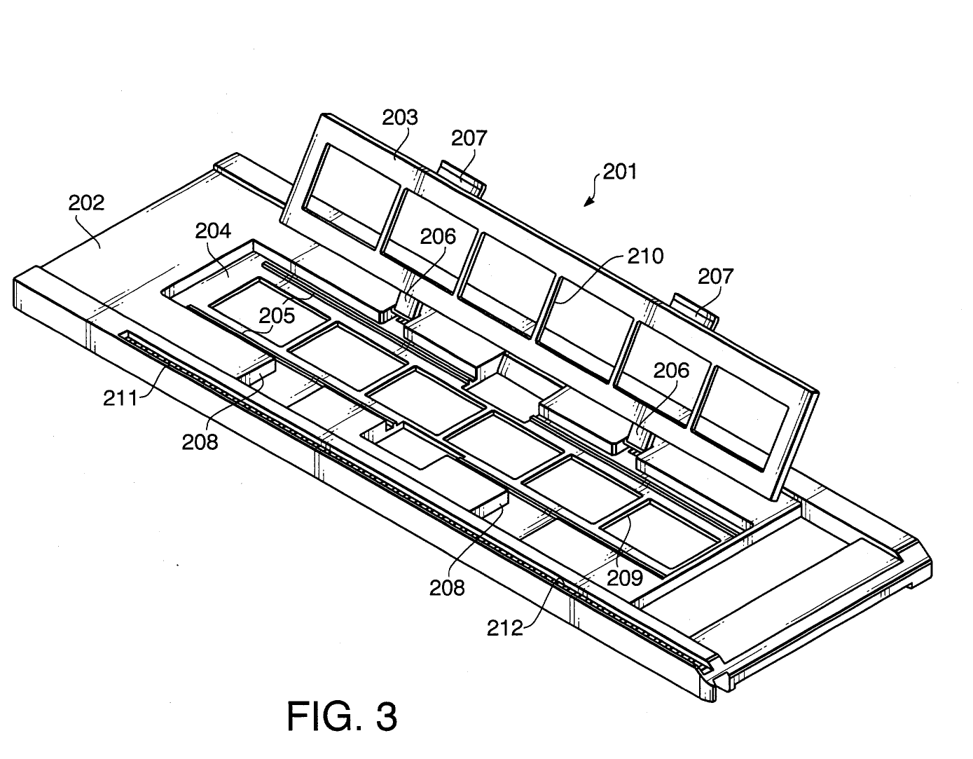

In this embodiment, the film holder 201 holds a 35 mm film strip containing six frames of images. As shown in FIG. 1, the film holder 201 includes a base 202 and a hinge cover 203 which is hinged on the base 202 by a pair of hinges 206 and 206 (see FIG. 3). The 35 mm film strip is held tight between the base 202 and the hinge cover 203 when the hinge cover 203 is closed.

On an upper surface of the base 202, a groove 211 is formed along the length of the film holder 201. The groove 211 has a bottom surface on which the rack 212 is formed. When the film holder 201 is inserted in the holder supporting groove 106 of the table 101, the pinion 109 of the pre-scan motor 108 engages with the rack 212 on the bottom surface of the groove 211 so as to move the film holder 201 in the auxiliary scanning direction relative to the table 101.

FIG. 3 is a perspective view of the film holder 201 in a situation where the hinge cover 203 is opened. As shown in FIG. 3, on the base 202, a concave portion 204 having a shallow depth is formed. On the concave portion 204, the 35 mm film strip is placed. The hinge cover 203 is configured such that it fits in the concave portion 204 when it is closed. Also, Projections 207 and 207 of the hinge cover 203 respectively fit in concave portions 208 and 208 formed on the base 202 along a side of the concave portion 204 when the hinge cover 203 is closed. With this structure, the hinge cover 203 can be keep closed.

On both of the hinge cover 203 and the base 202, six frame windows 210 and 209 respectively corresponding to the six images of the film strip are formed along the length of the film holder 201.

The concave portion 204 has a bottom surface on which a pair of guide rails 205 and 205 are formed along the length of the film holder 201. The film strip is inserted into the concave portion 204 with being guided by the pair of rails 205 and 205. The hinge cover 203 is closed after the film strip is placed on the concave portion 204 properly. With this structure, it becomes possible to hold tight the film strip between the hinge cover 203 and the bottom surface of the concave portion 204.

FIG. 4 is a perspective view of an appearance of the APS film adapter 301. As shown in FIG. 4, a casing 309 of the APS film adapter 301 generally takes the form of a flat rectangular solid, and has sleeve portions 302 and 302. As described above, the APS film adapter 301 can be inserted into the holder supporting groove 106 of the table 101.

On an upper surface of one sleeve portion 302, a groove 303 is formed along the length of the APS film adapter 301. Further, on a bottom surface of the groove 303 the rack 304 is formed throughout the length of the groove 303.

Substantially at the center of the film adapter 301, a frame window 305, which penetrates from the top surface to a bottom surface of the film adapter 301, is formed.

At a front portion of the top surface of the APS film adapter, electrodes 306, each of which takes the form of a protrusion, are arranged. When the APS film adapter 301 is inserted into the holder supporting groove 106 of the table 101, electrodes 306 contact with electrodes (not shown) formed in the holder supporting groove 106 of the table 101. Thus, the APS film adapter 301 and the table 101 are electrically connected to each other.

In the APS film adapter 301, an APS cartridge accommodating an APS film is incorporated. Also, in the APS film adapter 301, an internal motor are arranged. When the APS film adapter 301 is inserted into the holder supporting groove 106, is becomes possible to control the internal motor in the APS film adapter 301 so that a desired frame of image is selectively exposed through the frame window 305.

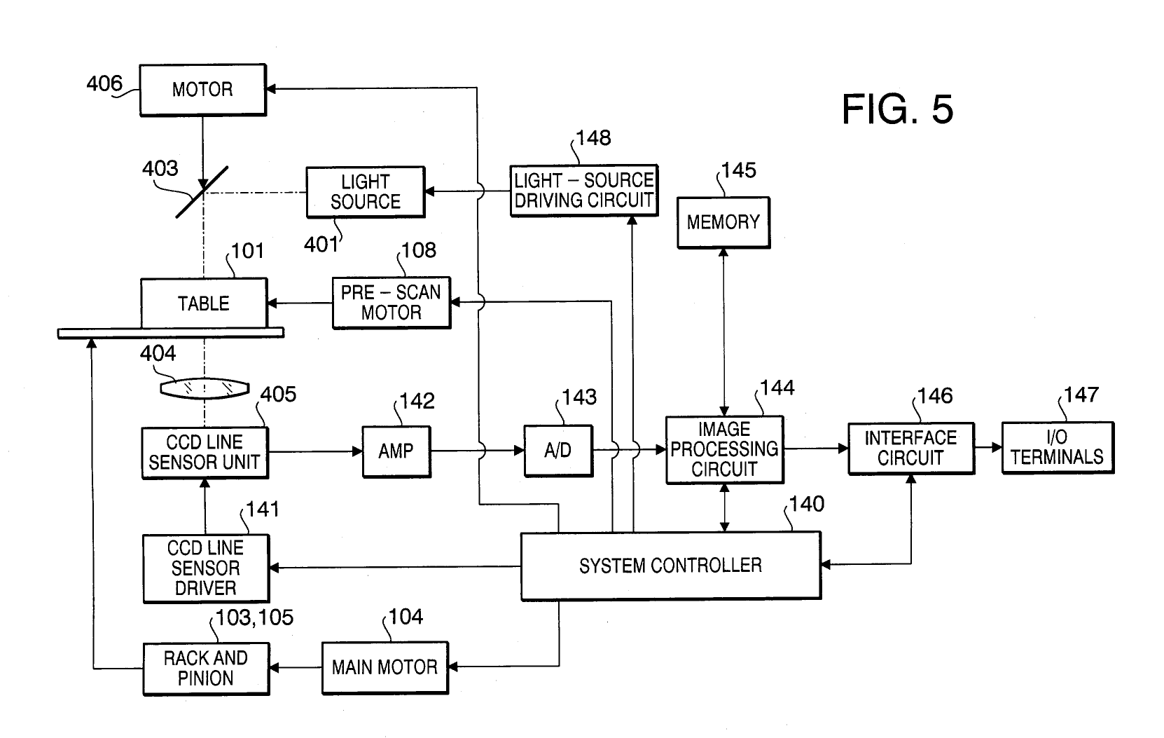

FIG. 5 is a circuit diagram of the film scanner 1000 according to the embodiment of the invention. To elements which are equal to elements shown in FIGS. 1-4, the same reference numbers are assigned.

As shown in FIG. 5, the CCD line sensor unit 405 is driven through a CCD line sensor driver 141 under control of a system controller 140. An image signal output by the CCD line sensor unit 405 is amplified by an AMP 142, and the amplified image signal is converted to digital form by a A-D converter 143. Then, the digital image signal is processed by a image processing circuit 144 to make image data and/or various signals including a composite video signal under control of the system controller 140.

A memory 145 is, for example, an IC card, and is used for storing the processed image as image data. The output of the image processing circuit 144 is also transmitted, via an interface circuit 146 (e.g., SCSI or USB), to I/O terminals 147, which may be connected to an external device such as a personal computer.

The light source 401 is controlled via a light source driving circuit 148 by the system controller 140. The main motor 104 is connected to the system controller 140 to control the position of the table 101 via the rack 103 and the pinion 105. The pre-scan motor 108 is connected to the system controller 140 to control the position of the film holder 201 or the APS film adapter 301. Further, the motor 406 is connected to the system controller 140 to control the angle of inclination of the deflecting mirror 403.

It should be noted that the film scanner 1000 includes various sensors to detect positions of the table 101, the base 202, the film holder 201, and the APS film adapter 301.

Next, a scanning operation of the film scanner 100 for capturing images on the film will be described.

As a preparation for the scanning operation, the film strip is inserted into the film holder 201 through the following steps. Firstly, the hinge cover 203 is opened as indicated in FIG. 3. Then, the film strip is placed on the concave portion 204. It should be noted that a position of the film strip along a width direction thereof is fixed by the pair of guide rails 205, and a position of the film strip along the length of the film strip is fixed by front and rear edges of the concave portion 204. After the film strip is properly placed on the concave portion 204, the hinge cover 203 is closed, i.e., fitted in the concave portion 204. The film holder 201 is then inserted into the holder supporting groove 106 to start the scanning operation.

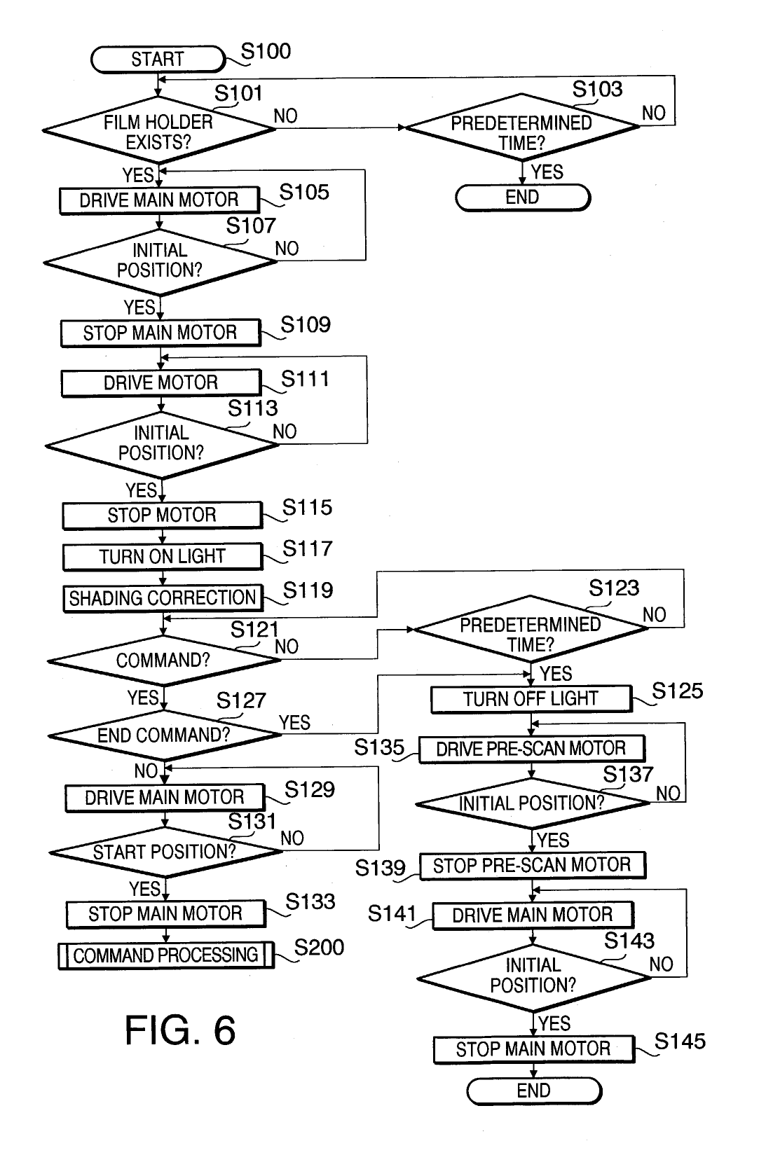

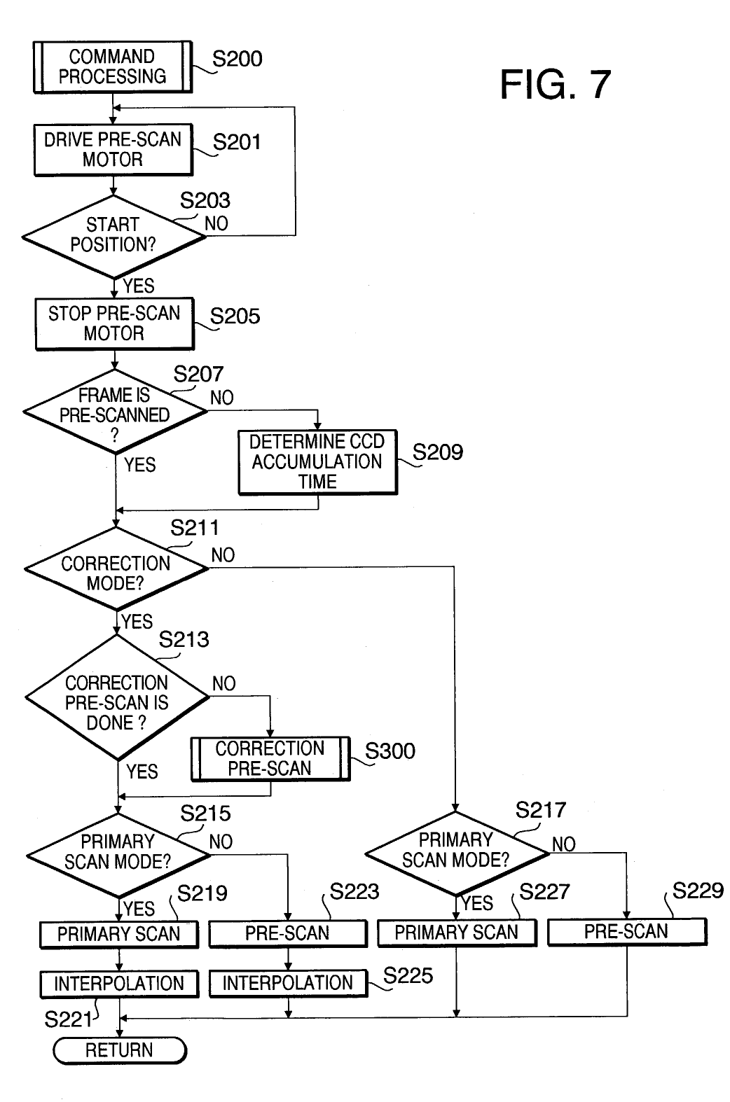

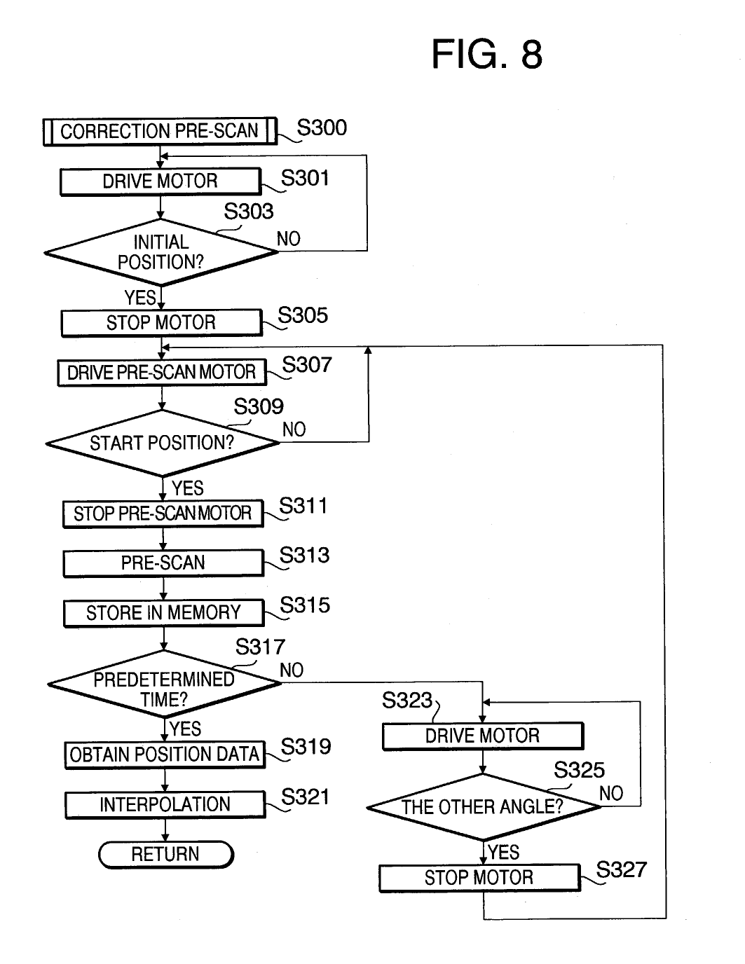

FIG. 6 is a flowchart illustrating the scanning operation of the film scanner. FIG. 7 is a flowchart illustrating a command processing called at step S200 in FIG. 6. FIG. 8 is a flowchart illustrating a correction pre-scan process called at step S300 in FIG. 7. The processes shown in FIGS. 6-8 are performed under control of the system controller 140.

The process shown in FIG. 6 is started, for example, when a power switch (not shown) of the film scanner 1000 is turned ON. In step S101, it is determined whether the film holder 201 is inserted into the table 101. If the film holder is not inserted (S101:NO), control proceeds to step S103 to determine whether a predetermined time period has elapsed. If the predetermined time period has elapsed (S103:YES), the scanning process is terminated. If the predetermined time period has not elapsed (S103:NO), control returns to step S101.

If the film holder 201 is inserted in the table 101 (S11:YES), control proceeds to step S105 where the system controller 140 drives the main motor 104 to move the table 101 to an initial position. In S107, it is determined whether the table 101 is located at the initial position. If the table 101 has not yet reached the initial position (S107: NO), the main motor 104 is kept driven (S105). If the table 101 has reached the initial position (S107: YES), control proceeds to S109 where the main motor 104 is stopped.

Next, in step S111, the system controller 140 drives the motor 406 to move the deflecting mirror 403 to an initial position in which the angle of inclination of the deflecting mirror 403 with respect to the horizontal plane is 45°. In S113, it is determined whether the deflecting mirror 403 is located at the initial position. If the deflecting mirror 403 has not yet reached the initial position (S113: NO), the motor 406 is kept driven (S111). If the deflecting mirror 403 has reached the initial position (S113: YES), control proceeds to S115 where the motor 406 is stopped.

Next, the system controller 140 turns ON the light source 401 to perform “shading correction” based on the output of the CCD line sensor unit 405 which receives light emitted by the light source 401 (S117,S119).

In step S121, it is determined whether a command is entered. If the command is not entered (S121:NO), control proceeds to step S123 to determine whether a predetermined time period has elapsed. If the predetermined time interval has elapsed (S123:YES), control proceeds to step S125 to execute a terminating process. If the predetermined time period has not elapsed (S123:NO), control returns to step S121.

If it is determined that the command is entered (S121:YES), control proceeds to step S127 to recognize the entered command. If the entered command is an end command (S127:YES), control proceeds to S125 to execute the terminating process.

If the entered command is not the end command, i.e., if the entered command is a primary scan command or a pre-scan command (S127:NO), control proceeds to step S129 where the main motor 104 is driven to move the table 101 to a scanning start position. In step S131, it is determined whether the table 101 is moved to the scanning start position. If the table 101 is not moved to the scanning start position (S131:NO), the main motor 104 is kept driven (S129). If the table 101 is moved to the scanning start position (S131:YES), control proceeds to step S133 to stop the main motor 104. Then, the command processing is executed (S200).

In the terminating process, the light source 401 is turned OFF (S125), and the pre-scan motor 108 is driven to move the film holder 201 to an initial position (S135, S137, S139). Then, the main motor 104 is driven to move the table 101 to the initial position (S141, S143, S145), and the scanning process is terminated.

Next, the command processing will be described with reference to FIG. 7. Initially, the system controller 140 drives the pre-scan motor 108 to move the film holder 201 to a scanning start position (S201). The scanning start position is defined as a position where a frame to be scanned is located on an optical axis of the reading optical system 400. In step S203, it is determined whether the film holder 201 is moved to the scanning start position. If the film holder 201 is not moved to the scanning start position (S203:NO), the pre-scan motor 108 is kept driven (S201). If the film holder 201 is moved to the scanning start position (S203:YES), control proceeds to step S205 to stop the pre-scan motor 108.

In step S207, it is determined whether the frame to be scanned (i.e., the frame moved to the position on the optical axis through the steps S201-205) has already underwent a pre-scan process. If the frame to be scanned has not underwent the pre-scan process (S207:NO), control proceeds to step S209 to determine accumulation time of the CCD line sensor unit 405.

In step S211, it is determined whether the film scanner 1000 is set to a correction mode. If the film scanner is set to the correction mode (S211:YES), control proceeds to S213 where it is determined whether a correction pre-scan process has already been executed. If the correction pre-scan process has not already been executed (S213:NO), the correction pre-scan process is executed in step S300. If the correction pre-scan process has already been executed (S213:YES), control proceeds to step S215 to determine whether the film scanner 1000 is set to a primary scan mode.

If the film scanner 1000 is set to the primary scan mode (S215:YES), a primary scan process is executed in step S219. Next, an interpolation process is executed (S221), and control returns to a main process. The interpolation process, which is described in detail later, is a process in which pixels corresponding to defects on the scanned image are interpolated based on position data obtained by the correction pre-scan process (S300) shown in FIG. 8.

If the film scanner is not set to the primary scan mode (S215:NO), the pre-scan process is executed in step S223. Next, the interpolation process is executed (S225), and control returns to the main process.

If the film scanner 1000 is not set to the correction mode (S211:NO), control proceeds to S217 where it is determined whether the film scanner 1000 is set the primary scan mode. If the film scanner 1000 is set to the primary scan mode (S217:YES), the primary scan process is executed (S227). If the film scanner 1000 is not set to the primary scan mode (S217:NO), the pre-scan process is executed in step S229. After the primary scan process (S227) or the pre-scan process (S229) is executed, control returns to the main process without executing the interpolation process.

In the primary scan process executed in S219 or S227, a fine image of a selected frame is generated. That is, in the primary scan process, an image portion corresponding to a portion of the selected frame that is illuminated with the collimated light is read from the CCD line sensor unit 405. Thus, the main scanning operation is performed.

Further, the main scanning operation is executed repeatedly while the table 101 is moved in the auxiliary scanning direction. In this case, auxiliary scanning pitches are relatively small because rotational pitches of the main motor 104 are relatively small. Therefore, a fine image can be generated. Thus, the primary scan process is completed.

In the pre-scan process executed in S223 or S229, a relatively rough image of the selected frame is obtained. That is, in the pre-scan process, an image portion corresponding to a portion of the selected frame that is illuminated with the collimated light is read from the CCD line sensor unit 405. Thus, the main scanning operation is performed.

Further, the main scanning operation is executed repeatedly while the film holder 201 inserted in the holder supporting groove 106 is moved in the auxiliary scanning direction. In this case, auxiliary scanning pitches are relatively large because rotational pitches of the pre-scan motor 108 are relatively large. Therefore, the relatively rough image is generated. Thus, the pre-scan process is completed. It should be noted that the relatively rough image generated through, the pre-scan process is used for the purpose of checking, for example, the subject on the selected frame, the density of the image, or a reading position of the selected frame.

Next, the correction pre-scan process executed in S300 in FIG. 7 will be described in detail with reference to FIG. 8. In step S301, the motor 406 is driven to move the deflecting mirror 403 to its initial position in which the angle of inclination of the deflecting mirror 403 with respect to the horizontal plane is an angle α1(45°). In step S303, it is determined whether the deflecting mirror 403 is moved to the initial position. If the deflecting mirror 403 is not moved to the initial position (S303:NO), the motor 406 is kept driven (S301). If the deflecting mirror 403 is moved to the initial position (S303:YES), control proceeds to step S305 to stop the motor 406.

Next, the system controller 140 starts to drive the pre-scan motor 108 to move the selected frame to the scanning start position (S307). In step S309, it is determined whether the selected frame is moved to the scanning start position. If the selected frame is not moved to the scanning start position (S309:NO), the pre-scan motor 108 is kept driven (S307). If the selected frame is moved to the scanning start position (S309:YES), control proceeds to step S311 to stop the pre-scan motor 108.

In step S313, the pre-scan process is started to obtain a relatively rough image of the selected frame. The obtained image is then stored in, for example, the memory 145 as image data (S315).

In step S317, it is determined whether the pre-scan process is executed a predetermined number of times. If the pre-scan process does not executed the predetermined number of times (S317:NO), control proceeds to S323 to slightly change the angle of inclination of the deflecting mirror 403 to an angle α2.

That is, in step S323, the system controller 140 starts to drive the motor 406. In step S325, it is determined whether the angle of inclination of the deflecting mirror 403 reaches the angle α2. If the angle of inclination of the deflecting mirror 403 does not reach the angle α2(S325:NO), the motor 406 is kept driven (S323). If the angle of inclination of the deflecting mirror 403 reaches the angle α2(S325:YES), control proceeds to step S327 to stop the motor 406.

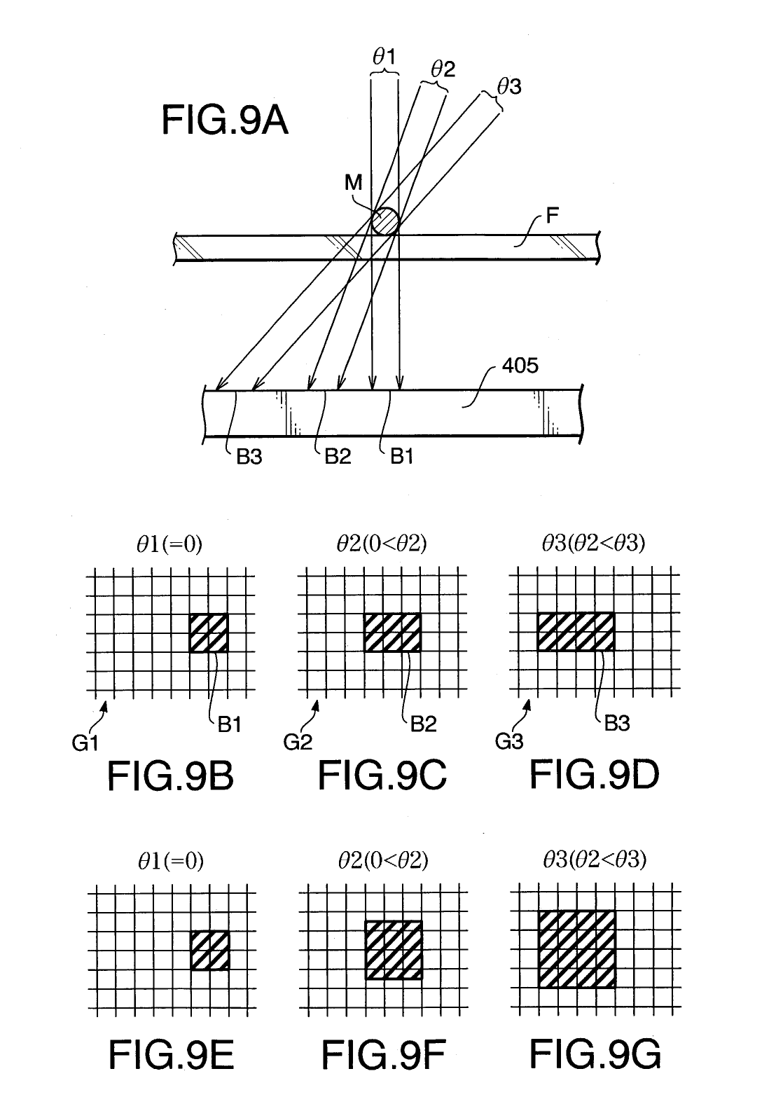

In this embodiment, the predetermined number of times that the pre-scan processes are executed on the same frame of image is three. The three pre-scan processes are executed at angles of inclination of α1, α2 and α3, respectively (see FIG. 9A). Thus, three pre-scan images on the same frame of image are obtained.

It should be noted that a position of the film holder 201 relative to the CCD line sensor unit 405 in the auxiliary scanning direction (i.e., a scanning start position in the auxiliary scanning direction) may be adjusted when the angle of inclination of the deflecting mirror 403 is changed so as to obtain the same pre-scan image of the frame at the changed angle of inclination of the deflecting mirror 403.

If it is determined that the pre-scan processes are executed the predetermined number of times (S317:YES), control proceeds to S319 where the position data of pixels corresponding to the extraneous subjects on the frame (i.e., pixels targeted for interpolation) is obtained. Then, the interpolation process is executed on the pixels corresponding to the extraneous subjects on the frame (S321).

Next, the process for obtaining the position data for interpolation executed through the steps shown in FIG. 8 will be described in detail with reference to FIGS. 9A-9G.

FIG. 9A, which is a side view of a part of the film scanner viewed along the arrow Y shown in FIG. 1, schematically shows a relationship of incident angles θ₁, θ₂ and θ₃ of the collimated light with respect to a film F. Three incident angles θ₁, θ₂ and θ₃ correspond to angles of inclination α1, α2 and α3 of the deflecting mirror 403 at which the three pre-scan images are obtained. As shown in FIG. 9A, a foreign particle M on the Film F cast a shadow B1 on the CCD line sensor unit 405 when the film F is illuminated with the collimated light at the incident angle θ₁. FIG. 9B (an image G1) shows a portion of the scanned image including the shadow B1 obtained using the collimated light at the incident angle θ₁ (θ₁=0°).

The foreign particle M on the Film F cast a shadow B2 on the CCD line sensor unit 405 when the film F is illuminated with the collimated light at the incident angle θ₂. FIG. 9C (an image G2) shows the same portion of the scanned image as the image G1 when the pre-scan image is obtained using the collimated light at the incident angle θ₂ (0°<θ₂)

The foreign particle M on the Film F cast a shadow B3 on the CCD line sensor unit 405 when the film F is illuminated with the collimated light at the incident angle θ₃. FIG. 9D (an image G3) shows the same portion of the image as the image G1 when the pre-scan image is obtained using the collimated light at the incident angle θ₃ (θ₂<θ₃)

FIGS. 9E-9G are the other examples of images including shadows cast by, for example, a scratch, on the Film F obtained using collimated light at incident angles θ₁, θ₂ and θ₃, respectively.

As can be seen FIG. 9A, the shadows B1-B3 (black pixels) appear at different positions on the same frame of image because the foreign particle M on the film receives light from different angles. Therefore, by comparing three images G1-G3 to detect a mismatch between the positions of shadows included in at least two of the images G1-G3, pixels corresponding to the detected mismatch can be determined as defects caused by the foreign particle M.

It should be noted that shift amounts among the positions of the shadows B1-B3 can be obtained theoretically based on a geometrical condition including incident angles θ₁-θ₃ of the collimated light. Therefore, the obtained shift amount may be taken into account to determine whether the detected mismatch corresponds to the defects caused by the foreign particle M.

In this embodiment, incident angles which have different signs and the same absolute value are considered as different incident angles.

If the pixels consisting the shadow B1 are determined as the defects in this way, pixels consisting the shadow B1 and a predetermined number of pixels surrounding the shadow B1 are determined as pixels targeted for the interpolation. Thus, the position data for the interpolation is obtained.

The interpolation process executed in S221, S225 or S321 may be a process using, for example, Nearest Neighbor, Bi-Linear, or Bi-Cubic. Nearest Neighbor is a method in which pixel data of a pixel nearest a target pixel (i.e., a pixel targeted for the interpolation) is used as pixel data of the target pixel.

Bi-Linear is a method in which pixel data of the target pixel is obtained by a weighted average of pixel data of four pixels adjacent to the target pixel according to distances between the target pixel and pixels adjacent to the target pixel.

Bi-Cubic is a method in which pixel data of the target pixel is obtained by a weighted average of pixel data of sixteen pixels surrounding the target pixel.

By executing the interpolation process, black pixels appeared on the image due to the extraneous subject on the film can be removed.

While the operation of the present invention is described with respect to the Nearest Neighbor, Bi-Linear, or Bi-Cubic process, the invention is not limited to the use of such processes, and other processes may be utilized without departing from the scope and/or spirit of the invention.

As described above, since collimated light is used to illuminate the film in this embodiment, a black portion on the captured image caused by the extraneous subject on the film has sharp edges and relatively high density. Accordingly, the black portion caused by the extraneous subject on the film can be reliably distinguished from other pixels in the captured image. Further, by comparing at least two images respectively captured using collimated light having different incident angles, the position data of pixels corresponding to the extraneous subject on the film, i.e., pixels targeted for the interpolation, are obtained.

In the embodiment, two kinds of film adapters (201 and 301) are described, however, it is appreciated that another type of film adapter for holding, for example, a “brownie” type film, or a slide film, may be employed.

Although the three images of the same frame at different incident angles of the collimated light are obtained by performing the pre-scan process in the above-mentioned embodiment, it is appreciated that the three images of the same frame may be obtained by performing the primary scanning process.

According to the embodiment of the invention, only one light source is required to identify pixels corresponding to the extraneous subject on the film. Therefore, cost and/or a room for accommodating the light source unit in the film scanner can be reduced.

According to the embodiment of the invention, high quality images can be obtained.

It is appreciated that processes shown in FIGS. 6-8 may be performed under control of the external device (for example, a personal computer) which is connected to the film scanner 1000 via the I/O terminals 147. In this case, a computer program for performing such processes shown in FIGS. 6-8 executes on the external device.

The present disclosure relates to the subject matter contained in Japanese Patent Application No. P2002-119469, filed on Apr. 22, 2002, which is expressly incorporated herein by reference in its entirety.

What is claimed is:

1. A film scanner for scanning images formed on a film, comprising:
an illuminating system that emits collimated light to illuminate the film;
an imaging device that receives the collimated light passed through the film to capture the images formed on the film;
a defect position obtaining system that obtains a plurality of images each of which corresponds to a frame of the film to be scanned using said imaging device, and obtains position data corresponding to a position of an extraneous substance on the film based on a difference between at least two of said plurality of images, said plurality of images being respectively obtained at different conditions of the collimated light incident on the film; and
an interpolating system that performs interpolation based on said position data obtained by said defect position obtaining system.

2. The film scanner according to claim 1,
wherein said illuminating system is capable of changing an incident angle of the collimated light with respect to the film,
wherein said defect position obtaining system obtains said plurality of images at different incident angles of the collimated light with respect to the film.

3. The film scanner according to claim 2, wherein said illuminating system includes:
a single light source which emits light; and
a collimator lens that collimates light emitted by said single light source.

4. The film scanner according to claim 3, wherein said illuminating system further includes:
a mirror that reflects the collimated light toward the film, and
an angle changing system that changes an angle of said mirror with respect to a predetermined plane to change the incident angle of the collimated light with respect to the film.

5. The film scanner according to claim 4, wherein said angle changing system includes a motor that rotates said mirror about a rotational axis thereof so as to change the angle of said mirror with respect to the predetermined plane.

6. The film scanner according to claim 1, wherein said defect position obtaining system obtains an image when an incident angle of the collimated light with respect to the film is zero and at least one image when the incident angle of the collimated light with respect to the film is not zero.

7. The film scanner according to claim 1, wherein said defect position obtaining system obtains said position data based on positions of black portions respectively formed on said plurality of images by the extraneous substance on the film.

8. The film scanner according to claim 1, wherein said defect position obtaining system obtains said position data based on a difference between positions of black portions of at least two of said plurality of images, the black portions being respectively formed on said plurality of images by the extraneous substance on the film.

9. The film scanner according to claim 8, wherein said defect position obtaining system obtains said position data by comparing the distance between the positions of the black portions of the at least two of said plurality of images with a theoretical distance between the positions of the black portions, said theoretical distance being calculated based on a geometrical condition including incident angles of the collimated light at which said at least two of said plurality of images are obtained.

10. The film scanner according to claim 1, wherein said interpolating system performs the interpolation using one of methods of Nearest Neighbor, Bi-Linear and Bi-Cubic.

11. The film scanner according to claim 1, wherein said imaging device includes:
a line image sensor unit for scanning said film in a main scanning direction; and
an auxiliary scanning system that moves said film relative to said line image sensor in an auxiliary scanning direction which is perpendicular to the main scanning direction.

12. The film scanner according to claim 1, further comprising a storing system that stores an image interpolated by said interpolating system into a memory.

13. The film scanner according to claim 12, wherein said memory is an IC-card.

14. The film scanner according to claim 1, further comprising an interface that is used to communicate with an external device so as to output an image interpolated by said interpolating system to said external device.

15. A film scanner for scanning images formed on a film, comprising:
an illuminating system that emits collimated light to illuminate the film;
an imaging device that receives the collimated light passed through the film to capture the images formed on the film;
a defect position obtaining system that obtains position data corresponding to a position of an extraneous substance on the film based on a position of a black portion on an image captured by said imaging device; and
an interpolating system that performs interpolation based on said position data obtained by said defect position obtaining system.

16. A film scanner for scanning images formed on a film, comprising:
an illuminating system that emits collimated light to illuminate the film;
an imaging device that receives the collimated light passed through the film to capture the images formed on the film; and
a defect position obtaining system that obtains a plurality of images each of which corresponds to a frame of the film to be scanned using said imaging device, and obtains position data corresponding to a position of an extraneous substance on the film based on a difference between at least two of said plurality of images, said plurality of images being respectively obtained at different conditions of the collimated light incident on the film.

17. A film scanning system for scanning images formed on a film, comprising:
a film scanner that includes an illuminating system which emits collimated light to illuminate the film and which is capable of changing conditions of the collimated light incident on the film, and an imaging device that receives the collimated light passed through the film to capture the images formed on the film; and
an external device that includes an interface for communicating with said film-scanner so as to control said film scanner,
wherein said external device includes:
a defect position obtaining system that obtains a plurality of images each of which corresponds to a frame of the film to be scanned using said imaging device, and obtains position data corresponding to a position of an extraneous substance on the film based on a difference between at least two of said plurality of images, said plurality of images being respectively obtained at different conditions of the collimated light incident on the film; and
an interpolating system that performs interpolation based on said position data obtained by said defect position obtaining system.

18. A method for correcting defects on a scanned image caused by an extraneous subject on a film, comprising:
performing a first scanning to obtain an image of a frame of the film to be scanned at a first incident angle of light incident on the film;
performing a second scanning to obtain an image of said frame of the film to be scanned at a second incident angle of light incident on the film; and
determining a position of said extraneous subject on the film using the image obtained at said first incident angle of light and the image obtained at said second incident angle of light.

19. A method for correcting defects on a scanned image caused by an extraneous subject on a film, comprising:
performing a first scanning to obtain an image of a frame of the film to be scanned at a first incident angle of light incident on the film;
performing a second scanning to obtain at least one image of said frame, the at least one image being obtained at a different incident angle of light incident on the film from said first incident angle; and
determining a position of said extraneous subject on the film using the image obtained at said first incident angle of light and the image obtained at said different incident angle of light from said first incident angle.
